(19) United States
(12) Patent Application Publication
(10) Pub. No.: US 2022/0221663 A1
(43) Pub. Date: Jul. 14, 2022

(54) FIBER LASER INSENSITIVE AIMING LASER

(71) Applicant: NLIGHT, INC., Camas, WA (US)

(72) Inventors: Dahv A.V. KLINER, Camas, WA (US); C. Geoffrey FANNING, Camas, WA (US)

(73) Assignee: NLIGHT, INC., Camas, WA (US)

(21) Appl. No.: 17/613,926

(22) PCT Filed: Jun. 4, 2020
(86) PCT No.: PCT/US2020/036180

§ 371 Date: Nov. 23, 2021

Related U.S. Application Data
(60) Provisional application No. 62/857,537, filed on Jun. 5, 2019.

(51) Int. Cl. G02B 6/42; H01S 3/0941; G02B 6/036; H01S 3/00; H01S 3/094

(52) U.S. Cl. CPC G02B 6/4207; H01S 3/0941; G02B 6/036; H01S 3/0675; H01S 3/094053; H01S 3/094003; H01S 3/0064

(57) ABSTRACT

A laser assembly comprising a multi-clad fiber optically coupled to a light source configured to emit optical radiation at a first wavelength and a protective element disposed between the light source and the multi-clad fiber so as to prevent a portion of backward-propagating optical radiation at a second wavelength from coupling into the light source.

### RELATED APPLICATIONS

The present application is a National Phase entry under 35 U.S.C. § 371 of International Application No. PCT/US2020/036180, filed on Jun. 4, 2020, which claims priority to U.S. Provisional Application No. 62/857,537, filed on Jun. 5, 2019, the entire contents of these applications are incorporated herein by reference in their entirety.

### TECHNICAL FIELD

The disclosure relates to methods and devices for backward-propagating radiation protection in fiber laser assemblies.

### BACKGROUND

High-power industrial fiber laser users are accustomed to fiber lasers emitting a visible “aiming beam” on demand for use in tool alignment using the naked eye. Regulatory requirements for such visible beams typically limit their output power to <1 mW. It is desirable that this power is transmitted through a user's choice of materials processing optics with little attenuation. The low attenuation requirement encourages incorporation of the alignment beam in the core of the fiber laser.

In an example fiber laser assemblies, a visible beam is injected into an output beam through a combiner. For example, as depicted in FIG. 1, laser assembly 100 produces a laser output beam 124 coaxial with a visible beam 134.

In this embodiment, assembly 100 includes pump laser beam sources 110, 112 that produce beams 111, 113 respectively. Beams 111, 113 propagate in respective fibers 114, 116. Fibers 114, 116 are spliced to combiner input fibers 120, 122. Combiner 102 receives and combines beams 111 and 113 to form a combined output beam 124 that is coupled into the cladding of combiner output fiber 126. Visible light source 132 produces visible beam 134 which is coupled to additional input fiber 140 and combiner 102 via Wavelength Division Multiplexer (WDM) 136. Combiner 102 couples visible beam 134 in the core of output fiber 126 that includes laser 154 comprising active fiber between high reflector fiber Bragg grating (HR FBG) 152 and partial reflector fiber Bragg grating (PR FBG) 150. Fiber 126 delivers laser output beam 124 to a laser head 128 that directs beam 124 to workpiece 130 to perform processing operations such as cutting, welding, brazing, additive manufacturing, or the like. Visible beam 134 is coaxial with beam 124 and can be used for guiding and alignment of beam 124 on workpiece 130.

During active operation the laser output beam 124 can reflect from a surface of workpiece 130 or cause workpiece 130 to emit radiation in response to incident beam 124. Both the emitted and reflected radiation may be coupled backward into the laser fiber core. This backward-propagating radiation 140 can travel back through input fibers and combiner 102 to reach and potentially damage upstream components. Damage caused by backward-propagating radiation can cause catastrophic failure. For example, backward-propagating radiation may damage or disable the source 132 of the visible aiming beam 134. One way to protect the visible light source 132 is to inject visible beam 134 through WDM 136 designed to transmit the aiming beam 134 into the fiber laser core and transmit backward-propagating radiation 140 from the fiber laser into an unused port such as WDM rejection port 138, where it may be safely dissipated. However, such a device is expensive and can add undesirable cost to a fiber laser.

The problem is to find a cost-effective method of injecting a visible aiming beam into the output of a high-power industrial fiber laser that is reliable under anticipated backward-propagating radiation.

### SUMMARY

Disclosed herein are assemblies, apparatus' and methods for reducing deleterious effects of backward-propagating radiation in a fiber laser. Such assemblies, apparatus' and methods include a laser assembly comprising multi-clad fiber optically coupled to a light source (e.g., a laser diode) configured to emit optical radiation at a first wavelength (e.g., in the visible spectrum) and a protective element disposed between the light source and the multi-clad fiber so as to prevent a portion of backward-propagating optical radiation at a second wavelength from coupling into the light source.

In an example, the multi-clad fiber may be double-clad fiber comprising a core, a cladding and a buffer layer, wherein the core has a higher refractive index than the cladding and the cladding has a higher index than the buffer layer. In a different example, the multi-clad fiber may be a triple-clad fiber comprising a core, a first cladding, a second cladding and a buffer layer, wherein the core has a higher refractive index than the first cladding, the first cladding has a higher index than the second cladding and the second cladding a higher index than the buffer layer.

The protective element may be a reflector or an absorber or a combination thereof. In an example, the protective element may be a dichroic filter configured to transmit optical radiation at the first wavelength and to reflect optical radiation at the second wavelength. Further, the protective element may reflect optical radiation at the second wavelength in such a way as to couple a portion of the backward-propagating optical radiation into one or more cladding layers of the multi-clad fiber and/or reflect optical radiation at the second wavelength in such a way as to direct the optical radiation away from a core of the multi-clad fiber.

In an example, the protective element may be a dichroic filter. The dichroic filter may be applied to an output end of the multi-clad fiber. In some cases the output end of the multi-clad fiber may be angled, curved or spherical. Additionally, or alternatively, a dichroic filter may be applied on the surface of a window that forms a portion of a package encapsulating the light source or on the surface of a protective element disposed adjacent to an output end of the multi-clad fiber.

The laser assembly may also include a focusing optic configured to focus the optical radiation at the first wavelength into the multi-clad fiber. In such a case, a dichroic filter may comprise a coating applied to a surface of the focusing optic. In an example, the multi-clad fiber may be a fiber pigtail configured to be optically coupled to an input fiber of a fiber laser. Such a pigtail may be further configured to couple the optical radiation at the first wavelength from the light source to the input fiber, wherein the first wavelength is in the visible spectrum and the fiber laser is configured to propagate the optical radiation through an output fiber to a workpiece. In an example, the fiber laser may be a diode pumped fiber laser or a counter-pumped fiber laser.

The foregoing and other objects, features, and advantages will become more apparent from the following detailed description, which proceeds with reference to the accompanying figures which may not be drawn to scale.

### BRIEF DESCRIPTION OF THE DRAWINGS

The accompanying drawings, wherein like reference numerals represent like elements, are incorporated in and constitute a part of this specification and, together with the description, explain the advantages and principles of the presently disclosed technology. In the drawings,

FIG. 1 illustrates an example laser assembly for directing a visible light beam coaxially with an output high-power laser beam including a WDM for back-reflection protection;

FIG. 2A illustrates an example laser assembly for generating and directing a high-power output laser beam with a coaxial visible light beam comprising a visible light source protection element;

FIG. 2B illustrates an example visible light source protection assembly for protecting a visible light source from damage by backward-propagating radiation;

FIG. 2C illustrates an example refractive index profile of a double-clad fiber configured for protecting a visible light source from damage by backward-propagating radiation;

FIG. 2D-2H illustrate a number of example visible light source protection assemblies for protecting a visible light source from damage by backward-propagating radiation;

FIG. 3A illustrates an example visible light source protection assembly for protecting a visible light source from damage by backward-propagating radiation;

FIG. 3B illustrates an example refractive index profile of a triple-clad fiber configured for protecting a visible light source from damage by backward-propagating radiation; and

FIG. 4 illustrates an example counter-pumped laser assembly for generating and directing a high-power output laser beam with a coaxial visible light beam comprising a visible light source protection element.

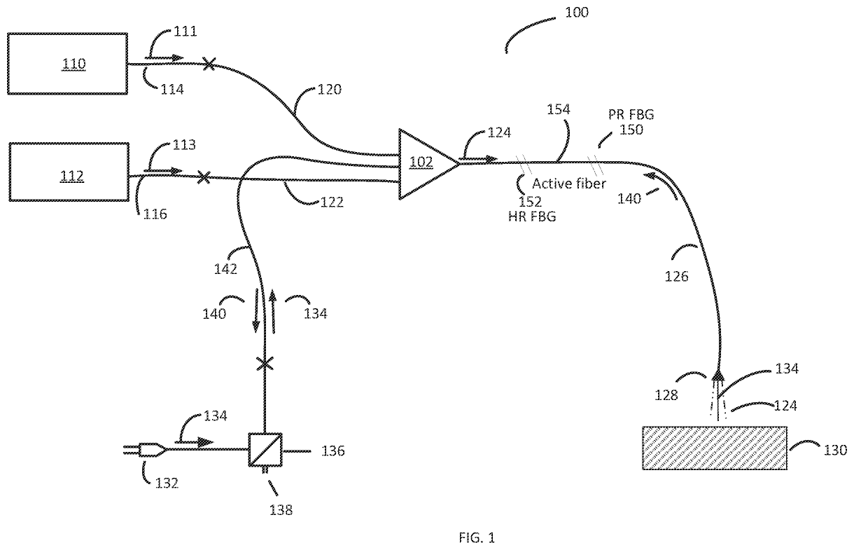

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. Moreover, in the following examples, laser components and assemblies are described at a high level of abstraction and do not include a complete description of all mechanical, electrical and optical elements necessary for operation.

As discussed above, a reliable and cost effective method of injecting a visible aiming beam into an output of a high-power industrial fiber laser is a desirable alternative to using expensive WDM devices to handle backward-propagating radiation at the visible light source. The approach proposed herein is to use a visible light source that reflects enough of the backward-propagating radiation back into the fiber laser to reduce the power of the radiation incident on the light source itself to a safe level without destabilizing the operation of the fiber laser.

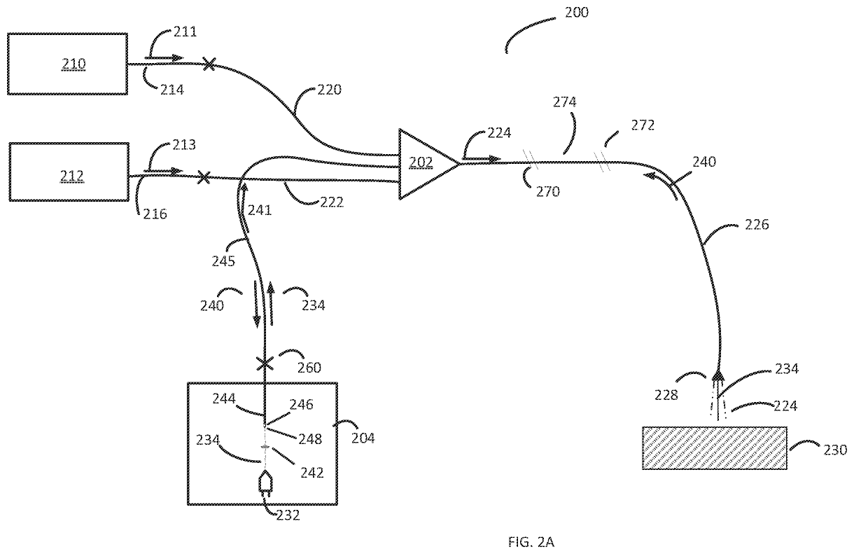

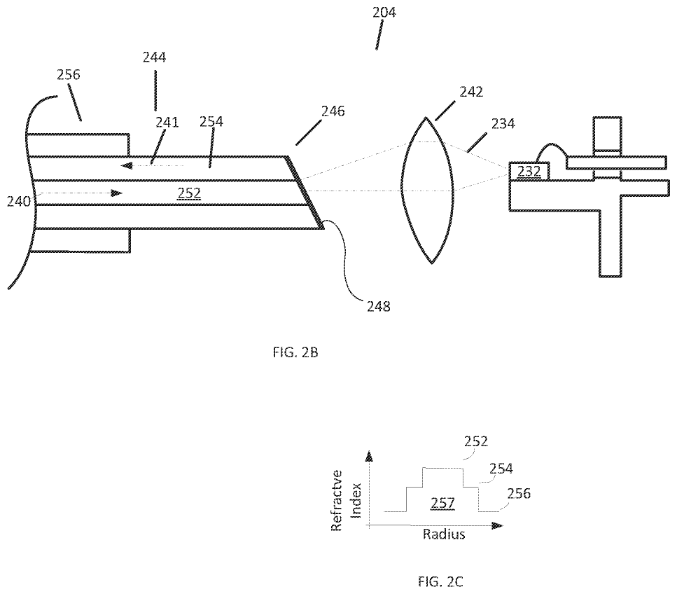

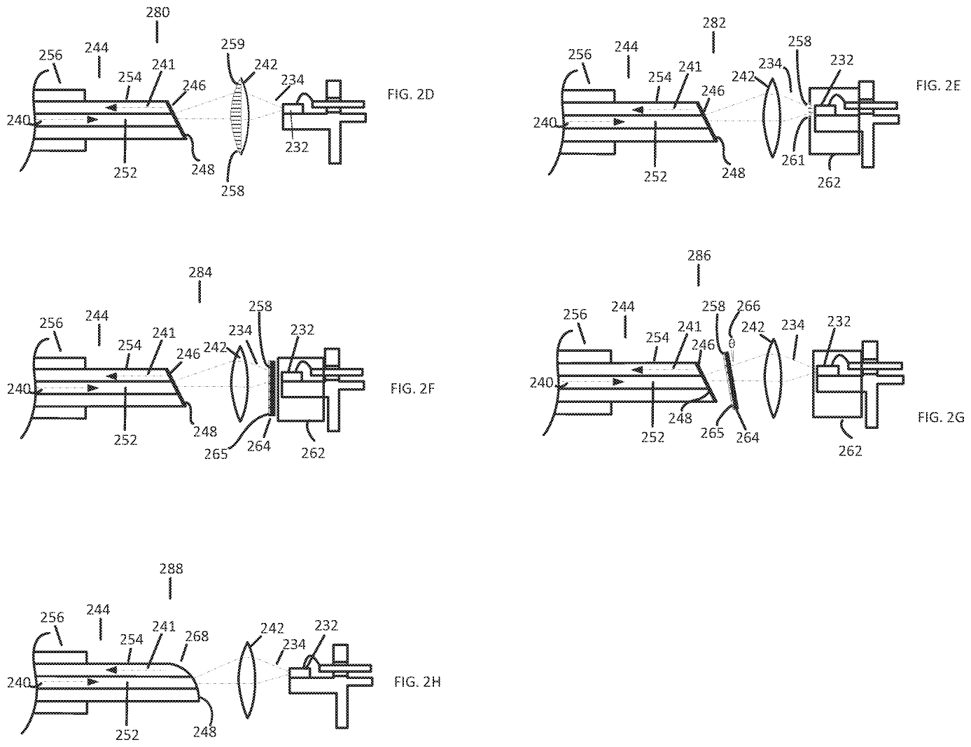

FIG. 2A illustrates an example a fiber laser assembly 200 for generating and directing a high-power output laser beam 224 with a coaxial visible light beam 234, wherein the assembly 200 incorporates a visible light source protection assembly 204 to protect a visible light source 232 from backward-propagating radiation 240. In an example, assembly 200 includes pump laser beam sources 210, 212 that produce beams 211, 213 respectively. Beams 211, 213 propagate in respective fibers 214, 216. Fibers 214, 216 are spliced to combiner input fibers 220, 222. Combiner 202 receives and combines beams 211 and 213 to form a combined output beam 224 that is coupled into the cladding of combiner output fiber 226. Combiner 102 couples visible beam 234 in the core of output fiber 226 that includes laser 274 comprising active fiber between HR FBG 272 and PR FBG 270.

Visible light source 232 produces visible beam 234 which is coupled to additional input fiber 240 and combiner 202. Combiner output fiber 226 delivers laser output beam 224 to workpiece 230 to perform a desired processing operation. Visible beam 234 is coaxial with beam 224 and can be used for guiding and alignment of beam 224 on workpiece 230.

In an example, combiner 202 is a pump/signal combiner arranged to couple light from an external source (i.e., the visible light source 232) into a fiber laser core. Combiner 202 may also couple light from the fiber laser core back into the external source. During operation, workpiece 230 may reflect incident light when irradiated by beam 224 and may emit light in response to incident laser light; both reflected and emitted light may be coupled backward into a core of output fiber 226. Such backward-propagating radiation 240 is propagated back through combiner 202 and into upstream components such as visible light source 232. In an example, visible light source protection assembly 204 is configured to protect visible light source 232 from backward-propagating radiation 240 as will be explained in further detail below.

Visible light source 232 may be a visible laser diode coupled to combiner 202 by a visible light source pigtail 244 coupled via splice 260 to optical fiber 245. Laser diodes are typically coupled in this way with single clad optical fiber, meaning the optical fiber confines light in a core of glass surrounded by a cladding of lower index glass that is itself surrounded by a cladding of higher index protective buffer material that does not propagate light in the glass cladding. Such a construction is not suitable for a fiber laser visible light source because the backward fiber laser radiation will not be confined only to the core but will also propagate in the cladding. If visible light source pigtail fiber 244 were single clad, backward-propagating radiation 240 coupled to pigtail fiber 244 would couple into the buffer causing fiber failure. To avoid such a failure mode, visible light source pigtail 244 comprises a double or triple-clad fiber.

FIG. 2B illustrates an example visible light source protection assembly 204 for protecting visible light source 232 from damage by backward-propagating radiation 240. In this example, visible light source pigtail 244 is a double-clad fiber comprising a low-loss buffer 256 with a lower index than the intermediate index glass cladding 254. Cladding 254 is configured to propagate clad coupled light with low loss and thus minimal risk to the integrity of buffer 256. The core 252 is a high-index glass comprising a higher index material than cladding 254.

In an example, core 252, cladding 254 and buffer 256 may comprise a variety of materials known to those skilled in the art to achieve the desired fiber structure and refractive index profile. As a non-limiting example, core 252 and cladding 254 may comprise SiO₂, SiO₂ doped with GeO₂, germanosilicate, phosphorus pentoxide, phosphosilicate, Al₂O₃, aluminosilicate, or the like or any combinations thereof. Buffer 256 may comprise glass and/or polymer materials such as fluoropolymers such as polyvinylidene fluoride (Kynar), polytetrafluoroethylene (Teflon), and polyurethane, or the like or any combinations thereof.

Pigtail fiber 244 may transmit backward-propagating radiation 240 sufficient to damage the visible light source 232. In some cases even the backward-propagating light 240 guided in the core 252 could damage visible light source 232. In an example, a protective element comprising a dichroic coating 248 configured to prevent backward-propagating radiation 240 from coupling into visible light source 232 may be applied to the end face 246 of fiber 244. Such a protective element may reflect the incident backward-propagating radiation 240 back into the fiber laser 274. The dichroic filter coating 248 may be designed to sufficiently transmit the visible light 234 to be injected into the core 252 while reflecting the potentially damaging wavelengths of the backward-propagating radiation 240 that is at wavelengths other than the visible light source wavelength. Any wavelength in the visible light spectrum will be suitable. Typically, the potentially damaging wavelengths will be the primary high-power laser wavelength (e.g., as a non-limiting example, 1000 to 1100 nm for Yb, 1900 to 2100 for Tm), with possible broadening due to non-linear effects such as self-phase modulation, and other wavelengths generated from the primary high-power laser wavelength by non-linear effects such as Stimulated Raman Scattering (SRS).

Light propagating backward from the fiber laser should not be coupled by reflection from the visible laser source into the core of the fiber laser or there is risk of seeding a destabilizing non-linear process like SRS or changing the output of the laser or amplifier with an unexpectedly broad seeding bandwidth. The core coupled Optical Return Loss (ORL) of the visible laser as measured from its fiber pigtail 244 should be low. Low ORL may be accomplished by angling the end-face 246 of the dichroically coated 248 optical fiber 244 interfacing to the visible laser source 232 so the reflection of backward-propagating radiation 240 off the end-face 246 is coupled out of the core 252 and into the fiber cladding 254.

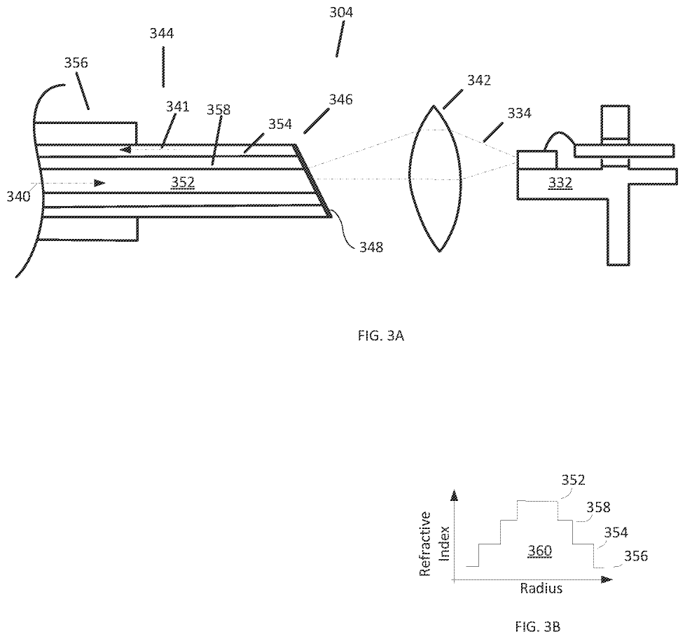

In this example, returned radiation 241 represents light that is reflected back into fiber 244 from one or more reflective components disposed in assembly 204. Returned radiation 241 is reflected from the dichroically coated 248 end-face 246 of optical fiber 244. It propagates primarily in the cladding 254 of the fiber pigtail 244 back toward the pump/signal combiner 202. Returned radiation 241 will be safely propagated by the cladding of the double clad fiber (or triple-clad fiber, see FIG. 3A) back to the pump/signal combiner 202. The pump/signal combiner 202 will couple returned radiation 241 primarily into the cladding of fiber 226 along with any pump light in fiber laser 274. That cladding coupled returned radiation 241 will propagate through the fiber laser portion 274 and could be emitted at the output end of the fiber laser or could be stripped out and safely dissipated in a Clad Light Stripper (CLS) used to remove unwanted fiber laser cladding emission.

FIG. 2C illustrates the relative refractive indices of core 252, cladding 254 and buffer 256. Refractive index profile 257 works together with reflective elements of assembly 204 to safely guide returned radiation 241 in the cladding back to the fiber laser. Other refractive index profiles known to those of skill in the art are possible and claimed subject matter is not limited by this or any other example.

FIG. 2D-2H illustrate various examples of visible light source protection assemblies 280-288 for protecting a visible light source from damage by backward-propagating radiation. The following examples are illustrative and not intended to be exhaustive or limit claimed subject matter. In the examples, like reference numerals represent like elements described with respect to FIGS. 2A and 2B above. Further, in each of FIG. 2D-2H, coating 258 comprises an optical filter or absorber such as for example a dichroic reflector. Coating 258 is configured to either absorb or reflect or otherwise filter backward-propagating radiation 240. Generally, if coating 258 is a reflector, it will return incoming backward-propagating radiation 240 to fiber 244. As the following examples illustrate, such returned radiation 241 can be substantially coupled into the cladding portion 254 of fiber 244 thereby protecting visible light source 232 from backward-propagating radiation 240. Coupling returned radiation 241 into the cladding 254 also minimizes the risk of damage to other components of fiber laser assembly 200.

FIG. 2D illustrates an example visible light source protection assembly 280 wherein focusing lens 242 used to couple light from the visible source 232 into fiber 244 comprises a coating 258 on surface 259 that is an optical filter such as a dichroic filter. Coating 258 is depicted as facing fiber surface 246. In another example, coating 258 could be applied to the portion of surface 259 facing visible light source 232. Fiber surface 246 of assembly 280 may or may not be angled and may optionally comprise an optical filter coating 248 as well. Angling surface 246 may inhibit coupling of returned radiation into core 252.

FIG. 2E illustrates an example visible light source protection assembly 282 wherein an optical filter coating 258 is applied to a surface of a protective element such as a window 261 in package 262 protecting visible light source 232 from the surrounding environment.

FIG. 2F illustrates an example visible light source protection assembly 284 wherein an optical filter coating 258 such as a dichroic filter is applied to a surface 265 of a protective element 264 dedicated to filtering out backward-propagating radiation 240. Protective element 264 may be positioned at a variety of locations within assembly 284 to protect the visible laser source 232, its fiber pigtail 244, and any intervening optics 242.

In another example, coating 258 may be an optical absorber configured to absorb radiation 240 rather than reflect a portion of the radiation 240. This approach may have more limited power-handling capability than other approaches described herein.

Additionally, or alternatively, other reflective surfaces may be disposed between the end face 246 of the fiber pigtail 244 and the visible light source 232 so as to minimize returned radiation 241 reflecting back into the fiber core.

FIG. 2G illustrates an example visible light source protection assembly 286 wherein protective element 264 may be tilted and/or shaped to help minimize coupling of reflected backward-propagating radiation 240 into core 252. The surface may be curved or spherical (see, FIG. 2H). The tilt angle θ has to be slight enough (e.g., 3-12 degrees) to couple light back into the fiber cladding and close enough to the fiber (e.g., 75-125 um) to couple into the cladding 254. If it is too far away the light will spread out and it won't couple well into the cladding 254. Returned radiation 241 reflected back into fiber 244 by protective element 264 may be coupled into the cladding 254 to be safely carried back toward the fiber laser 274.

FIG. 2H illustrates an example visible light source protection assembly 288 wherein the end-face 268 of the fiber 244 may be shaped so the reflection of core guided light is poorly coupled back into fiber core 252. The surface may be curved or spherical or another shape known to those of skill in the art to aid in controlling a reflection angle on backward-propagating radiation 240. Further, optical filter coating 248 may be applied to curved end-face 268 and may allow visible light 234 to couple into fiber core 252 and reflect a portion of backward-propagating radiation 240 sending returned radiation 241 to the fiber laser 274. In some examples, end-face 268 surface shape may be selected to promote coupling of visible beam 234 thus obviating the need for lens 242.

In some examples, including those depicted in FIG. 2A-2H, a visible light fiber pigtail may comprise a triple-clad fiber. FIG. 3A illustrates an example visible light source protection assembly 304 for protecting visible light source 332 from damage by backward-propagating radiation 340 wherein the visible light source pigtail 344 is a triple-clad fiber.

In an example, backward-propagating radiation 340 is reflected by dichroic coating 348 on angled end-face 346 and preferentially coupled back into cladding layers of fiber 344 as returned radiation 341.

Visible light source pigtail 344 comprises a low-loss buffer 356 having a lower index than first glass cladding 354 and second glass cladding 358. In an example, the refractive index of cladding 354 is lower than the refractive index of cladding 358 to confine a fraction of the clad light to second (inner) cladding 358 to prevent it from interacting substantially with buffer 356. Core 352 comprises a higher index material than first cladding 358 and second cladding 354. The triple-clad fiber also uses a buffer 356 with lower index of refraction than the first (outer) cladding 354 to promote low loss propagation of the fraction of light confined in the outer cladding 354, further reducing the possibility of heating damage to the fiber buffer 356.

In an example, core 352, first cladding 358, second cladding 354 and buffer 356 may comprise a variety of materials known to those skilled in the art to achieve the desired refractive index profile. As a non-limiting example, core 352, first cladding 358, and second cladding 354 may comprise SiO₂, SiO₂ doped with GeO₂, germanosilicate, phosphorus pentoxide, phosphosilicate, Al₂O₃, aluminosilicate, or the like or any combinations thereof. Buffer 356 may comprise glass and/or polymer materials such as fluoropolymers such as polyvinylidene fluoride (Kynar), polytetrafluoroethylene (Teflon), and polyurethane, or the like or any combinations thereof.

FIG. 3B depicts an example refractive index profile 360 showing relative refractive indices of core 352, first cladding 358, second cladding 354 and buffer 356. Refractive index profile 360 works together with reflective elements of assembly 304 to safely guide returned radiation 341 in the cladding back to the fiber laser. Other refractive index profiles known to those of skill in the art are possible and claimed subject matter is not limited by this or any other example.

A counter-pumped architecture would use a pump/signal combiner at the output end of the fiber laser to couple pump light propagating backward into the fiber laser relative to the intended fiber laser output direction. In such an architecture the visible light source pigtail could still be spliced into the fiber laser behind the high reflective Fiber Bragg Grating forming the back end of the fiber laser oscillator.

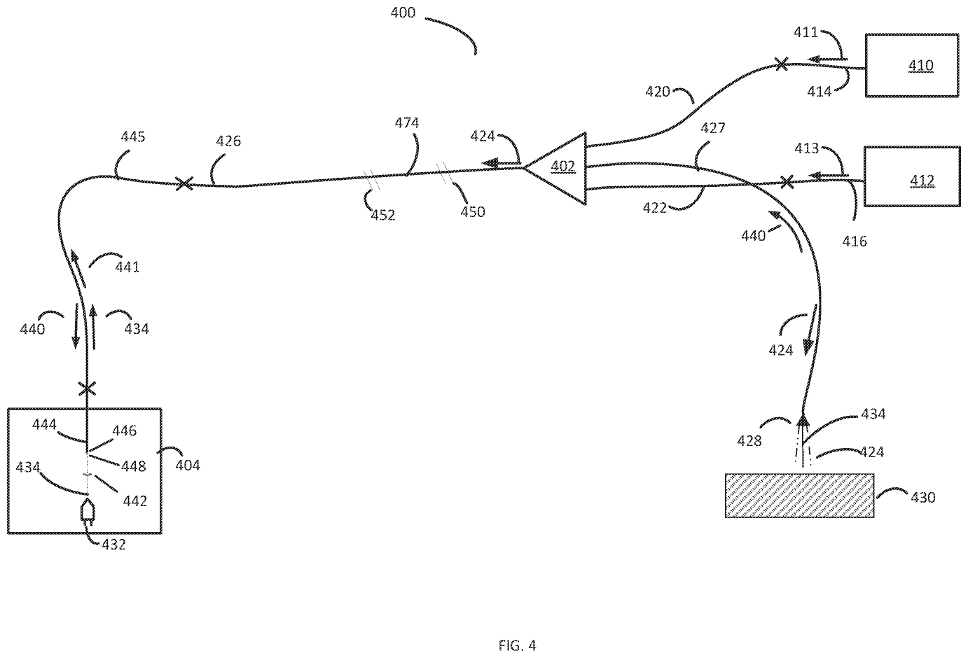

FIG. 4 illustrates an example counter-pumped fiber laser assembly 400 for generating and directing a high-power output laser beam 424 with a coaxial visible light beam 434, wherein the assembly 400 incorporates a visible light source protection assembly 404 to protect a visible light source 432 from backward-propagating radiation 440. In an example, assembly 400 includes pump laser beam sources 410, 412 that produce beams 411, 413 respectively. Beams 411, 413 propagate in respective fibers 414, 416. Fibers 414, 416 are spliced to combiner input fibers 420, 422. Combiner 402 receives and combines beams 411 and 413 to form a combined output beam 424 that is coupled into a combiner gain fiber 426. Combiner gain fiber 426 includes laser 474 comprising active fiber between HR FBG 452 and PR FBG 450.

Visible light source 432 produces visible beam 434 which is coupled to gain fiber core 426 via additional input fiber 445 and is from there coupled to output fiber 427 through combiner 402. Combiner output fiber 426 delivers laser output beam 424 with coaxial visible aiming beam 434 to workpiece 430 to perform a desired processing operation. Backward-propagating radiation 440 is reflected and emitted from workpiece 430 and propagates back to visible light source pigtail 444 via fiber 427, combiner 402, gain fiber 426, and fiber 445.

In this example, visible light source pigtail 444 is a double or triple-clad fiber as described with respect to FIG. 2B or 3A. Visible light source protection assembly 404 protects visible light source 432 from damage by backward-propagating radiation 440 by reflecting and/or absorbing all or a portion of radiation 440 according to the methods discussed above. Specifically, angled fiber end-face 446 comprises an optical filter material, coating 448 is configured to reflect backward-propagating radiation 440. The reflection of backward-propagating radiation 440 off the end-face 446 is coupled out of the core 452 and into the cladding layers of visible light source pigtail 444. Visible light source protection assembly 404 may include different or additional reflective elements configured to reflect radiation 440 back into pigtail 444. In FIG. 4, returned radiation 441 represents such reflected radiation. Returned radiation 441 will be safely propagated by the cladding of fiber pigtail 444 back through laser 474 to combiner 402. That cladding coupled returned radiation 441 may propagate through the fiber laser portion 474 and could be emitted at the output end or could be stripped out and safely dissipated in a CLS.

Having described and illustrated the general and specific principles of examples of the presently disclosed technology, it should be apparent that the examples may be modified in arrangement and detail without departing from such principles. We claim all modifications and variation coming within the spirit and scope of the following claims.

1. A laser assembly comprising:
a multi-clad fiber optically coupled to a light source configured to emit optical radiation at a first wavelength; and
a protective element disposed between the light source and the multi-clad fiber so as to prevent a portion of backward-propagating optical radiation at a second wavelength from coupling into the light source.

2. The laser assembly according to claim 1, wherein the light source is a diode laser.

3. The laser assembly according to claim 1, wherein the first wavelength is in the visible spectrum.

4. The laser assembly according to claim 1, wherein the multi-clad fiber is double-clad fiber comprising a core, a cladding and a buffer layer, wherein the core has a higher refractive index than the cladding and the cladding has a higher index than the buffer layer.

5. The laser assembly according to claim 1, wherein the multi-clad fiber is a triple-clad fiber comprising a core, a first cladding, a second cladding and a buffer layer, wherein the core has a higher refractive index than the first cladding, the first cladding has a higher index than the second cladding and the second cladding a higher index than the buffer layer.

6. The laser assembly according to claim 1, wherein the protective element is a reflector or an absorber or a combination thereof.

7. The laser assembly according to claim 1, wherein the protective element is a dichroic filter configured to transmit optical radiation at the first wavelength and to reflect optical radiation at the second wavelength.

8. The laser assembly according to claim 1, wherein the protective element is a dichroic filter configured to reflect optical radiation at the second wavelength in such a way as to couple a portion of the backward-propagating optical radiation into one or more cladding layers of the multi-clad fiber.

9. The laser assembly of claim 8, wherein the dichroic filter is applied to an output end of the multi-clad fiber.

10. The laser assembly of claim 9, wherein the output end of the multi-clad fiber is angled.

11. The laser assembly of claim 9, wherein the output end of the multi-clad fiber is spherical.

12. The laser assembly of claim 8, further comprising a focusing optic configured to focus the optical radiation at the first wavelength into the multi-clad fiber, wherein the dichroic filter is a coating applied to a surface of the focusing optic and wherein the first wavelength is in the visible spectrum.

13. The laser assembly of claim 8, wherein the dichroic filter is applied on the surface of a window that forms a portion of a package encapsulating the light source.

14. The laser assembly of claim 8, wherein the dichroic filter is applied on the surface of a protective element disposed adjacent to an output end of the multi-clad fiber.

15. The laser assembly of claim 14, wherein the output end is coated with a dichroic filter.

16. The laser assembly of claim 15, wherein the output end is angled.

17. The laser assembly of claim 8, wherein the multi-clad fiber is a fiber pigtail configured to be optically coupled to an input fiber of a fiber laser.

18. The laser assembly of claim 17, wherein the pigtail is further configured to couple the optical radiation at the first wavelength from the light source to the input fiber, wherein the first wavelength is in the visible spectrum and the fiber laser is configured to propagate the optical radiation through an output fiber to a workpiece.

19. The laser assembly of claim 18, wherein the fiber laser is a diode pumped fiber laser.

20. The laser assembly of claim 18, wherein the fiber laser is a counter-pumped fiber laser.

21. The laser assembly according to claim 1, wherein the protective element is configured to reflect optical radiation at the second wavelength in such a way as to direct the optical radiation away from the core.
